(19) United States
(12) Patent Application Publication
(10) Pub. No.: US 2021/0042660 A1
(43) Pub. Date: Feb. 11, 2021

(54) COMPATIBILITY DETERMINATION APPARATUS, COMPATIBILITY DETERMINATION METHOD AND PROGRAM

(71) Applicant: OMRON Corporation, Kyoto-shi, Kyoto (JP)

(72) Inventors: Hiroshi IMAI, Ikoma-shi (JP); Tetsuji YAMATO, Yokohama-shi (JP); Taiji YOSHIKAWA, Kizugawa-shi (JP)

(73) Assignee: OMRON Corporation, Kyoto-shi, KYOTO (JP)

(21) Appl. No.: 16/963,945

(22) PCT Filed: Nov. 29, 2018
(86) PCT No.: PCT/JP2018/043937

§ 371 Date: Jul. 22, 2020

(30) Foreign Application Priority Data
Feb. 27, 2018 (JP) 2018-033041

(51) Int. Cl. G06N 20/00

(52) U.S. Cl. CPC G06N 20/00

(57) ABSTRACT

A compatibility determination apparatus, a compatibility determination method and a program that are configured to determine the compatibility of an agent that outputs input data to a processing module are provided. The processing module is a learned model generated by using a plurality of learning data. Each of the plurality of learning data includes input data and a ground truth label of output data associated with the input data. First metadata is associated with the processing module. The first metadata is generated based on a probability density function of a plurality of input data associated with a ground truth label common to each thereof. The compatibility determination apparatus acquires the first metadata, and determines the compatibility based on the first metadata.

### TECHNICAL FIELD

The present invention relates to a compatibility determination apparatus, a compatibility determination method, and a program.

### RELATED ART

JP 2014-45242A (Patent Document 1) discloses a virtual sensor generation apparatus that generates a virtual sensor. In this virtual sensor generation apparatus, a real sensor that exists within a predetermined range is detected, and a virtual sensor is generated by using the detected real sensor (refer to Patent Document 1).

### RELATED ART DOCUMENTS

### Patent Documents

Patent Document 1: JP 2014-45242A

### SUMMARY OF THE INVENTION

### Problems to be Solved by the Invention

A virtual sensor such as disclosed in Patent Document 1 includes a real sensor (example of device) and a processing module, for example. The processing module is, for example, a learned model generated by using a plurality of learning data, and, by processing sensing data (example of input data) output by the real sensor, generates output data that differs from the input data.

In such cases, when the data output by a device that has completely different attributes from the device used to generate the learning data is input to the processing module, a situation can arise where the original function of the learned model is not exhibited, resulting in the virtual sensor not being able to exhibit a desired function.

The present invention has been made in order to solve such problems, and an object thereof is to provide a compatibility determination apparatus, a compatibility determination method and a program that are capable of determining the compatibility of a device that outputs input data to a processing module.

### Means for Solving the Problems

A compatibility determination apparatus according to an aspect of the present invention is configured to determine the compatibility of an agent that outputs input data to a processing module. The processing module is a learned model generated by using a plurality of learning data, and is configured to generate, based on at least one piece of input data, output data that differs from the input data. Each of the plurality of learning data includes input data and a ground truth label of output data associated with the input data. First metadata is associated with the processing module. The first metadata is generated based on a probability density function of a plurality of input data associated with a ground truth label common to each thereof. The compatibility determination apparatus includes a first acquisition unit and a determination unit. The first acquisition unit is configured to acquire the first metadata. The determination unit is configured to determine the compatibility based on the first metadata.

As mentioned above, the processing module is a learned model generated by using a plurality of learning data. The learned model is premised on the attributes of the device that output the learning data, and thus will not necessarily output the desired result in the case where data output by a device with completely different attributes is input. In this compatibility determination apparatus, first metadata is generated based on the probability density function of a plurality of input data (included in the learning data) associated with a ground truth label (included in the learning data) common to each thereof, and the compatibility of the device is determined based on the first metadata. That is, in this compatibility determination apparatus, the compatibility of the device is determined, after having adequately taken the attributes of the device that output the learning data into consideration. Accordingly, with this compatibility determination apparatus, the compatibility of the device that outputs input data to the processing module can be determined more accurately.

Also, the compatibility determination apparatus may further include a buffer and a probability density function generation unit. The buffer is configured to temporarily store input data output to the processing module by the agent. The probability density function generation unit is configured to generate a probability density function of a plurality of input data stored in the buffer. The determination unit may be configured to determine the compatibility of the device based on the first metadata and the probability density function generated by the probability density function generation unit.

In this compatibility determination apparatus, the compatibility of the device is determined based on the probability density function of a plurality of input data output to the processing module by the device and the first metadata. Accordingly, with this compatibility determination apparatus, the probability density function of a plurality of input data output to the processing module by the device is also taken into consideration, thus enabling the compatibility of the device outputting the input data to the processing module to be determined more accurately.

Also, the first metadata may be the probability density function of the plurality of input data associated with the ground truth label common to each thereof. The determination unit may be configured to determine that the agent is compatible, in the case where the degree of similarity between the first metadata and the probability density function generated by the probability density function generation unit is greater than or equal to a predetermined value.

In this compatibility determination apparatus, it is determined that the device is compatible in the case where the degree of similarity between the first metadata and the probability density function generated by the probability density function generation unit is greater than or equal to a predetermined value. That is, in this compatibility determination apparatus, it is determined that a device whose output tendency approximates the device that output the learning data is compatible. Accordingly, with this compatibility determination apparatus, the determination criteria are appropriate, thus enabling the compatibility of the device outputting the input data to the processing module to be determined more accurately.

Also, second metadata may be associated with the agent. The second metadata is generated based on the probability density function of a plurality of input data each output to the processing module by the agent. In a case where each of the plurality of input data is input to the processing module, the processing module outputs common output data. The compatibility determination apparatus may further include a second acquisition unit. The second acquisition unit is configured to acquire the second metadata. The determination unit may be configured to determine the compatibility of the device based on the first and second metadata.

In this compatibility determination apparatus, the compatibility of the device is determined based on the first and second metadata. Accordingly, with this compatibility determination apparatus, the attributes of the device outputting the input data to the processing module are adequately taken into consideration by referring to the second metadata, thus enabling the compatibility of the device outputting the input data to the processing module to be determined more accurately.

Also, the first metadata may be the probability density function of the plurality of input data associated with the ground truth label common to each thereof. The second metadata may be the probability density function of the plurality of input data each output to the processing module by the device. The determination unit may be configured to determine that the device is compatible, in the case where the degree of similarity between the first and second metadata is greater than or equal to a predetermined value.

In this compatibility determination apparatus, it is determined that the device is compatible in the case where the degree of similarity between the first and second metadata is greater than or equal to a predetermined value. That is, in this compatibility determination apparatus, it is determined that a device whose output tendency approximates the device that output the learning data is compatible. Accordingly, with this compatibility determination apparatus, the determination criteria are appropriate, thus enabling the compatibility of the device outputting the input data to the processing module to be determined more accurately.

Also, the agent may be a sensor, and the input data may be sensing data output by the sensor.

Also, the processing module may be configured to generate the output data based on a plurality of input data.

Also, a virtual sensor may be formed by the processing module and the device that outputs input data to the processing module.

A metadata generation method according to another aspect of the present invention determines the compatibility of an agent that outputs input data to a processing module. The processing module is a learned model generated by using a plurality of learning data, and is configured to generate, based on at least one piece of input data, output data that differs from the input data. Each of the plurality of learning data includes input data and a ground truth label of the output data associated with the input data. First metadata is associated with the processing module. The first metadata is generated based on a probability density function of a plurality of input data associated with a ground truth label common to each thereof. The compatibility determination method includes a step of acquiring the first metadata, and a step of determining the compatibility based on the first metadata.

In this compatibility determination method, first metadata is generated based on the probability density function of a plurality of input data (included in the learning data) associated with a ground truth label (included in the learning data) common to each thereof, and the compatibility of the device is determined based on the first metadata. That is, in this compatibility determination method, the compatibility of the device is determined, after having adequately taken the attributes of the device that output the learning data into consideration. Accordingly, with this compatibility determination method, the compatibility of the device that outputs input data to the processing module can be determined more accurately.

A program according to another aspect of the present invention causes a computer to execute processing for determining the compatibility of an agent that outputs input data to a processing module. The processing module is a learned model generated by using a plurality of learning data, and is configured to generate, based on at least one piece of input data, output data that differs from the input data. Each of the plurality of learning data includes input data and a ground truth label of the output data associated with the input data. First metadata is associated with the processing module. The first metadata is generated based on a probability density function of a plurality of input data associated with a ground truth label common to each thereof. The program is configured to cause the computer to execute a step of acquiring the first metadata, and a step of determining the compatibility of the device based on the first metadata.

When this program is executed by a computer, first metadata is generated based on the probability density function of a plurality of input data (included in the learning data) associated with a ground truth label (included in the learning data) common to each thereof, and the compatibility of the device is determined based on the first metadata. That is, when this program is executed by a computer, the compatibility of the device is determined, after having adequately taken the attributes of the device that output the learning data into consideration. Accordingly, with this program, the compatibility of the device that outputs input data to the processing module can be determined more accurately.

### Effects of the Invention

According to the present invention, a compatibility determination apparatus, a compatibility determination method and a program that are capable of determining the compatibility of a device that outputs input data to a processing module can be provided.

### BRIEF DESCRIPTION OF THE DRAWINGS

FIG. 1 is a diagram for describing an outline of a compatibility determination apparatus.

FIG. 2 is a diagram showing an example of a sensor network system in a first embodiment.

FIG. 3 is a diagram showing an example of the hardware configuration of a virtual sensor management server in the first embodiment.

FIG. 4 is a diagram showing an example of a learning data DB.

FIG. 5 is a diagram showing an example of a first metadata DB.

FIG. 6 is a diagram showing an example of part of the software configuration (including first metadata generation module) of the virtual sensor management server.

FIG. 7 is a diagram showing an example of part of the software configuration (including compatibility determination module) of the virtual sensor management server in the first embodiment.

FIG. 8 is a flowchart showing an example of operations for generating first metadata.

FIG. 9 is a flowchart showing an example of operations for determining the compatibility of a sensing device in the first embodiment.

FIG. 10 is a diagram showing a sensor network system in a second embodiment.

FIG. 11 is a diagram showing the hardware configuration of a virtual sensor management server in the second embodiment.

FIG. 12 is a diagram showing an example of a second metadata DB.

FIG. 13 is a diagram showing an example of part of the software configuration (including compatibility determination module) of a virtual sensor management server in the second embodiment.

FIG. 14 is a flowchart showing an example of operations for determining the compatibility of a sensing device in the second embodiment.

### EMBODIMENTS OF THE INVENTION

Hereinafter, embodiments (hereinafter, also referred to as “the present embodiment”) according to an aspect of the present invention will be described in detail using the drawings. Note that the same reference signs are given to portions that are the same or similar in the drawings, and description thereof will not be repeated. Also, the present embodiment described below is, in all respects, merely an illustrative example of the present invention. Various improvement and modifications can be made to the present embodiment within the scope of the present invention. That is, in implementing the present invention, a specific configuration can be adopted as appropriate according to the embodiment.

### 1. First Embodiment

### 1-1. Outline

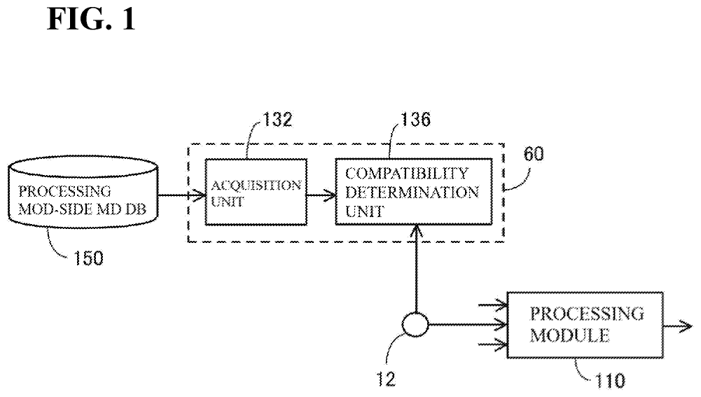

FIG. 1 is a diagram for describing an outline of a compatibility determination apparatus 60 according to the present embodiment. Referring to FIG. 1, a processing module 110 has at least one input port, and sensing data (example of input data) output by a sensing device 12 (example of device) is input to each input port. The processing module 110 is configured to generate output data that differs from the input data based on the input data. That is, a so-called virtual sensor is formed, by the processing module 110 and the sensing device 12 (input sensor) that outputs the input data to the processing module 110. A virtual sensor is a sensor module that outputs, as sensing data, a result of observing a different target from a target observed by the input sensor, based on sensing data generated by the input sensor observing the target. The virtual sensor will be described in detail later.

The processing module 110 is a learned model generated by using a plurality of learning data. The learning data respectively includes input data (sensing data output by the sensing device 12) to the processing module 110 and a ground truth label of the output data of the processing module 110 in the case where this input data is input.

A processing module-side metadata DB (hereinafter, also referred to as “first metadata DB”) 150 stores metadata (hereinafter, also referred to as “first metadata”) of the processing module 110 generated based on this learning data. Specifically, the first metadata is generated based on the probability density function of a plurality of input data associated with a ground truth label (included in the learning data used at the time of generating the processing module 110) common to each thereof.

When data output by a sensing device 12 that has completely different attributes from the sensing device 12 used in generating the learning data is input to the processing module 110, a situation can arise where the original function of the learned model is not exhibited, resulting in the virtual sensor not being able to exhibit a desired function.

The compatibility determination apparatus 60 according to the present embodiment determines the compatibility of the sensing device 12 that outputs input data to the processing module 110, in order to avoid such a situation.

Specifically, the compatibility determination apparatus 60 is provided with an acquisition unit 132 and a compatibility determination unit 136. The acquisition unit 132 acquires first metadata associated with the processing module 110. The compatibility determination unit 136 determines the compatibility of the sensing device 12, based on the first metadata.

In this compatibility determination apparatus 60, the first metadata is generated based on the probability density function of a plurality of input data (included in the learning data) associated with a ground truth label (included in the learning data) common to each thereof, and the compatibility of the sensing device 12 is determined based on the first metadata. That is, in this compatibility determination apparatus 60, the compatibility of the sensing device 12 is determined, after having adequately taken the attributes of the sensing device 12 that output the learning data into consideration. Accordingly, with this compatibility determination apparatus 60, the compatibility of the sensing device 12 that outputs input data to the processing module 110 can be determined more accurately.

### 1-2. Configuration

### 1-2-1. Configuration of Overall System

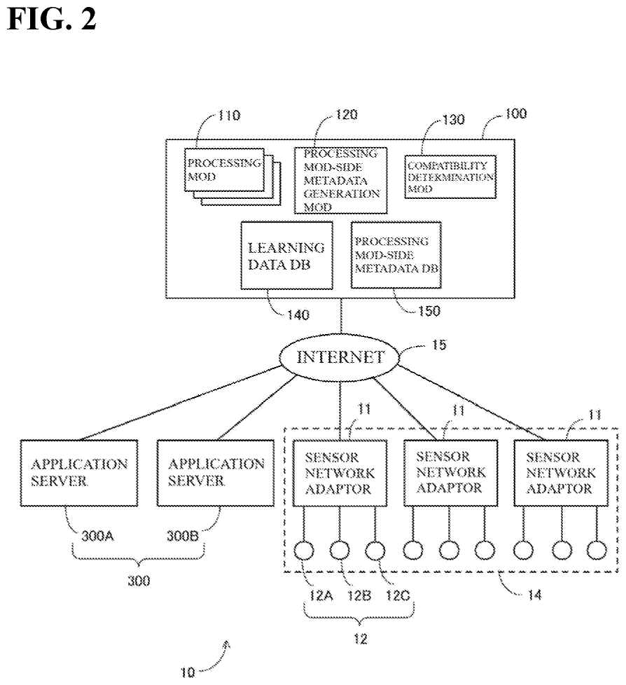

FIG. 2 is a diagram showing an example of a sensor network system 10 that includes a processing module-side metadata generation module (hereinafter, also referred to as “first metadata generation module”) 120 according to the first embodiment. In the example of FIG. 2, the sensor network system 10 includes a sensor network unit 14, a virtual sensor management server 100, and application servers 300.

The sensor network unit 14, the virtual sensor management server 100 and the application servers 300 are connected to each other in a communicable manner via an internet 15. Note that the number of constituent elements (virtual sensor management server 100, application server 300, sensor network adaptor 11, sensing device 12, etc.) included in the sensor network system 10 is not limited to that shown in FIG. 2.

Sensing data generated by the sensing device 12 or the like is distributable in the sensor network system 10. For example, sensing data generated by the sensing device 12 can be distributed to the virtual sensor management server 100, and sensing data generated by the virtual sensor can be distributed to the application servers 300.

The sensor network unit 14 includes a plurality of sensor network adaptors 11, for example. A plurality of sensing devices 12 are connected to each of the plurality of sensor network adaptors 11, and the sensing devices 12 is respectively connected to the internet 15 via the sensor network adaptors 11.

The sensing devices 12 are configured to obtain sensing data by observing a target. The sensing devices 12 include, for example, an image sensor (camera), a temperature sensor, a humidity sensor, an illuminance sensor, a force sensor, a sound sensor, a speed sensor, an acceleration sensor, a RFID (Radio Frequency IDentification) sensor, an infrared sensor, an attitude sensor, a rainfall sensor, a radiation sensor and a gas sensor. Also, the sensing devices 12 do not necessarily need to be fixedly installed devices, and may be mobile devices such as a mobile phone, a smartphone, and a tablet. Also, each sensing device 12 does not necessarily need to be constituted by a single sensor, and may be constituted by a plurality of sensors. Also, the sensing devices 12 may be installed for any purpose, and may, for example, be installed for FA (Factory Automation) and production control in a factory, urban transport control, weather and other environmental measurement, health care and crime prevention.

In the sensor network unit 14, the sensor network adaptors 11 are arranged in different (geographically separate) places and the sensing devices 12 that are connected to the sensor network adaptors 11 are disposed in the same (geographically close) place, but the places where these devices are disposed are not limited thereto.

The application servers 300 (300A, 300B) are configured to execute applications that utilize sensing data, and, for example, are realized by a general-purpose computer. The application servers 300 acquire required sensing data via the internet 15.

The virtual sensor management server 100 is a server for realizing the virtual sensor. In the virtual sensor management server 100, a plurality of processing modules 110, a first metadata generation module 120 and a compatibility determination module 130 are realized, and a learning data DB 140 and a first metadata DB 150 are managed. The plurality of processing modules 110, the first metadata generation module 120 and the compatibility determination module 130 are software modules, for example.

The processing modules 110 include at least one input port, and are configured to generate output data that differs from input data based on the input data input to each input port. The processing modules 110 are capable of switching the sensing device 12 that outputs input data to the input ports as necessary. For example, in the case where the sensing device 12 currently outputting input data to the input ports fails, the processing modules 110 are able to switch the input sensor to another sensing device 12.

The processing modules 110 may, for example, be configured to output data indicating the number of persons present in a room, based on input data (audio data) that is output by a sound sensor disposed in the room. In this case, a virtual sensor that detects the number of persons in a room can be realized by the processing modules 110 and the sensing devices 12 (sound sensors).

The first metadata generation module 120 is configured to generate first metadata that is associated with the processing modules 110. The compatibility determination module 130 is configured to determine the compatibility of the sensing device 12 outputting input data to the processing modules 110. The software modules and databases will be described in detail later.

### 1-2-2. Hardware Configuration of Virtual Sensor Management Server

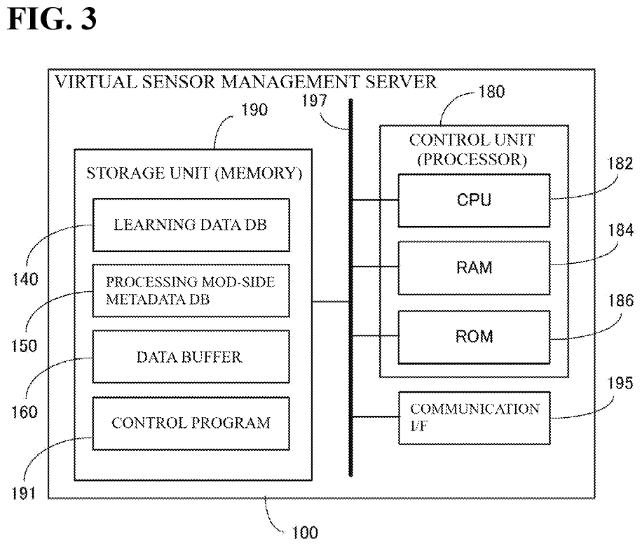

FIG. 3 is a diagram showing an example of the hardware configuration of the virtual sensor management server 100. Note that, in the first embodiment, the virtual sensor management server 100 is realized by a general-purpose computer, for example.

In the example in FIG. 3, the virtual sensor management server 100 includes a control unit 180, a communication I/F (interface) 195 and a storage unit 190, and the constituent elements are electrically connected via a bus 197.

The control unit 180 includes a CPU (Central Processing Unit) 182, a RAM (Random Access Memory) 184 and a ROM (Read Only Memory) 186, and is configured to control the constituent elements according to information processing.

The communication I/F 195 is configured to communicate with external apparatuses (e.g., application servers 300 and sensor network unit 14 (FIG. 2)) provided externally to the virtual sensor management server 100, via the internet 15. The communication I/F 195 is constituted by a cable LAN (Local Area Network) module or a wireless LAN module, for example.

The storage unit 190 is an auxiliary storage device such as a hard disk drive or a solid-state drive, for example. The storage unit 190 is configured to store the learning data DB 140, the first metadata DB 150, and a control program 191, for example. Also, a data buffer 160 is provided in part of the storage area of the storage unit 190.

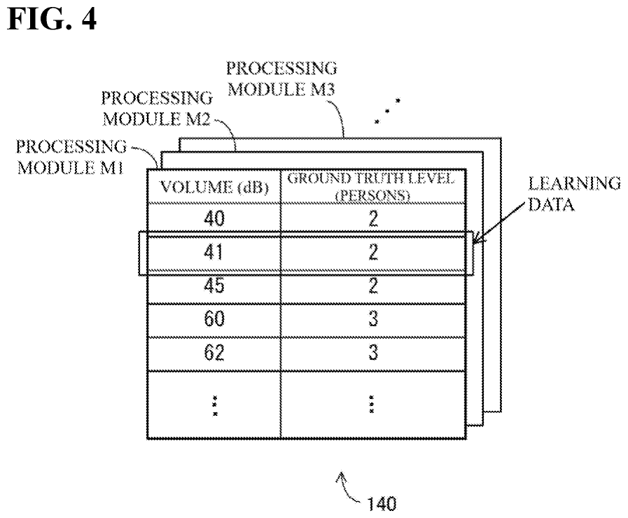

FIG. 4 is a diagram showing an example of the learning data DB 140. In the example in FIG. 4, learning data used at the time of generating the processing modules 110 is managed in the learning data DB 140. In this example, a processing module M1 is configured to output the number of persons present in a room where a sound sensor is disposed, based on input data (volume data) output by the sound sensor. In this case, each of a plurality of learning data used in generating the processing module M1 includes volume data and a ground truth label (correct value) of the output data (number of persons in the room) of the processing module 110 in the case where this volume data is input.

Note that although it is assumed the processing module M1 generates one piece of output data based on one piece of input data, the processing modules 110 do not necessarily need to generate one piece of output data based on one piece of input data. The processing modules 110 may, for example, generate one piece of output data based on a plurality of input data.

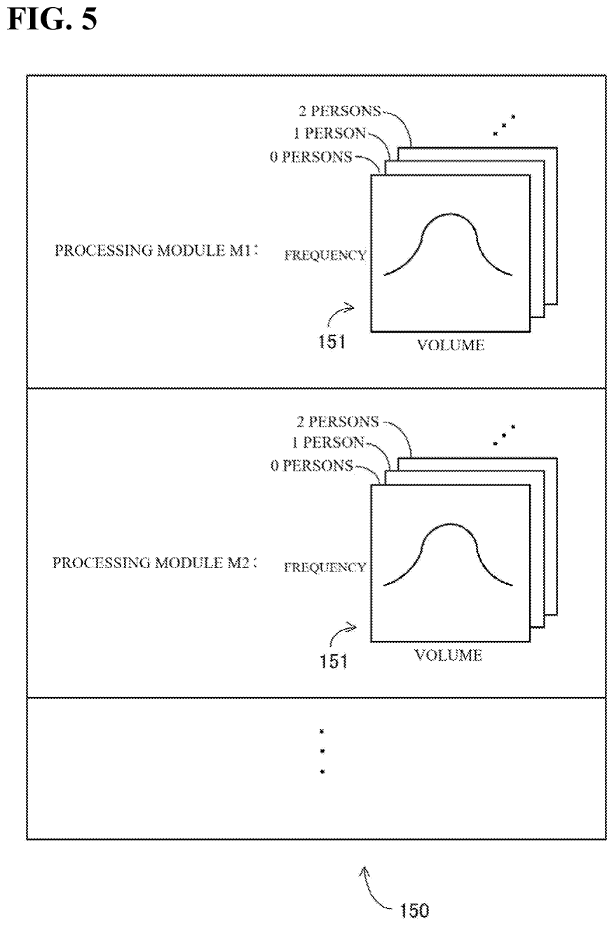

FIG. 5 is a diagram showing an example of the first metadata DB 150. In the example in FIG. 5, first metadata 151 of each processing module 110 is managed in the first metadata DB 150. Each first metadata 151 is generated based on a plurality of learning data used at the time of generating the processing module 110 associated therewith. The first metadata that is associated with the processing modules 110, including the generation method and utilization method, will be described in detail later.

Referring again to FIG. 3, the data buffer 160 is configured to temporarily store the sensing data output to the processing modules 110 by the sensing device 12. The compatibility of the sensing device 12 outputting the sensing data to the processing modules 110 is determined, based on the sensing data temporarily stored in the data buffer 160. The compatibility determination method will be described in detail later.

The control program 191 is a control program of the virtual sensor management server 100 that is executed by the control unit 180. For example, the processing modules 110, the first metadata generation module 120 and the compatibility determination module 130 may be realized, by the control unit 180 executing the control program 191. In the case where the control unit 180 executes the control program 191, the control program 191 is extracted to the RAM 184. The control unit 180 then controls the constituent elements, by the control program 191 extracted to the RAM 184 being interpreted and executed by the CPU 182.

### 1-2-3. Software Configuration of Virtual Sensor Management Server

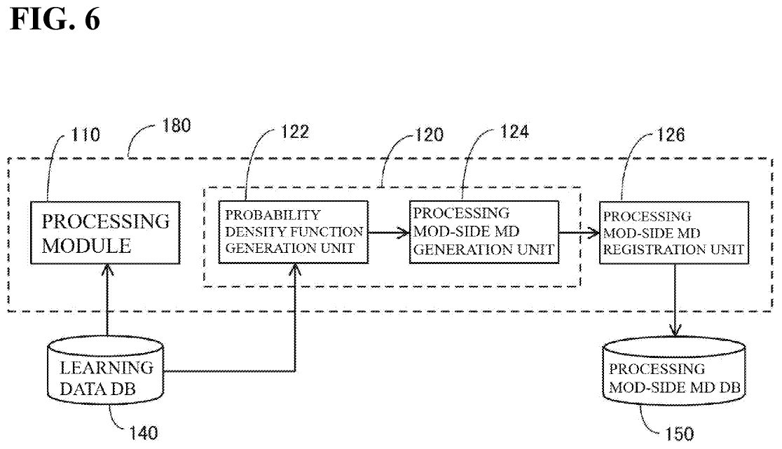

FIG. 6 is a diagram showing an example of part of the software configuration (including first metadata generation module 120) of the virtual sensor management server 100. In the example in FIG. 6, the processing modules 110, the first metadata generation module 120 and a first metadata registration unit 126 are realized, by the control unit 180 executing the control program 191.

As mentioned above, the processing modules 110 are generated by performing learning that uses a plurality of learning data that is stored in the learning data DB 140.

The first metadata generation module 120 is configured to generate metadata (first metadata) that is associated with the processing modules 110, based on the learning data used in generating the processing modules 110. The first metadata generation module 120 includes a probability density function generation unit 122 and a processing module-side metadata generation unit (hereinafter, also referred to as “first metadata generation unit”) 124.

The probability density function generation unit 122 reads out a plurality of learning data used in generating the processing modules 110 from the learning data DB 140. The probability density function generation unit 122 generates the probability density function of a plurality of input data associated with a ground truth label common to each thereof. The probability density function generation unit 122 generates a probability density function for every ground truth label. That is, a plurality of probability density functions are generated in the probability density function generation unit 122. Note that, in the case where one piece of input data is input to the processing modules 110, the probability density functions will be two dimensional, as shown in the first metadata 151 in FIG. 5, whereas in the case where a plurality of input data are input to the processing modules 110, the number of dimensions of the probability density function increases according to the increase in the number of input data.

The first metadata generation unit 124 generates first metadata (e.g., first metadata 151 in FIG. 5), based on the plurality of probability density functions generated by the probability density function generation unit 122. For example, the first metadata generation unit 124 takes, as first metadata, data that compiles the plurality of probability density functions generated by the probability density function generation unit 122.

The first metadata registration unit 126 registers the first metadata generated by the first metadata generation unit 124 in the first metadata DB 150 in association with the processing modules 110. In the virtual sensor management server 100 according to the first embodiment, the first metadata of each processing module 110 is registered in the first metadata DB 150. The first metadata registered in the first metadata DB 150 is used in various use applications.

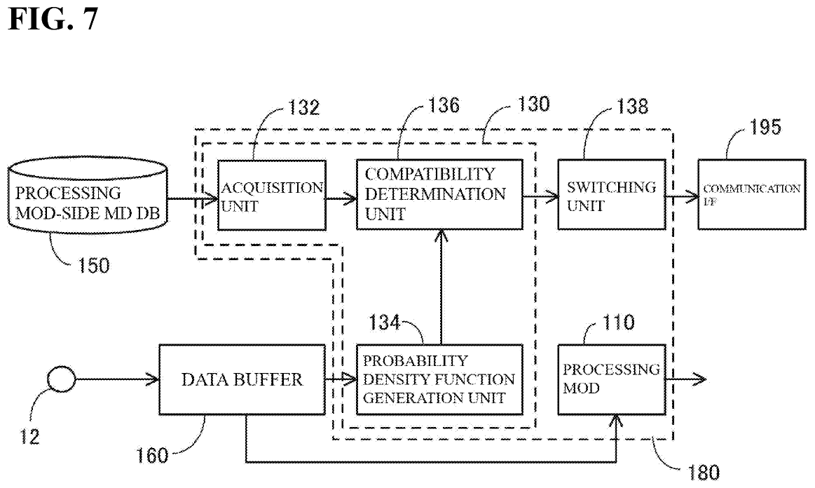

FIG. 7 is a diagram showing an example of part of the software configuration (including compatibility determination module 130) of the virtual sensor management server 100. The configuration shown in the example in FIG. 7 utilizes the first metadata registered in the first metadata DB 150. Note that the compatibility determination module 130, a switching unit 138 and the processing modules 110 are realized by the control unit 180 executing the control program 191.

The compatibility determination module 130 determines the compatibility of the sensing device 12 outputting input data to the processing modules 110, based on the first metadata associated with the processing modules 110 and the input data to the processing modules 110. The compatibility determination module 130 includes the acquisition unit 132, a probability density function generation unit 134, and the compatibility determination unit 136.

The acquisition unit 132 acquires the first metadata that is associated with the processing modules 110 from the first metadata DB 150. Note that the sensing data output by the sensing device 12 that is to undergo compatibility determination is input to the processing modules 110. The sensing data output by the sensing device 12 is temporarily stored in the data buffer 160.

The probability density function generation unit 134 generates the probability density function of a plurality of sensing data (input data) temporarily stored in the data buffer 160. This plurality of sensing data is generated during a time period in which the environment around the sensing device 12 does not change greatly. That is, the probability density function that is generated by the probability density function generation unit 134 is a probability density function of the sensing data (input data to the processing modules 110) that is output by the sensing device 12 in a common environment, and indicates the attributes (output tendency) of the sensing device 12.

The compatibility determination unit 136 determines the compatibility of the sensing device 12, based on the first metadata acquired by the acquisition unit 132 and the probability density function generated by the probability density function generation unit 134. The compatibility determination unit 136 determines whether the degree of similarity between any of the plurality of probability density functions included in the first metadata and the probability density function generated by the probability density function generation unit 134 is greater than or equal to a predetermined value, for example. Note that various known methods are used in calculating the degree of similarity.

The compatibility determination unit 136 determines that, in the case where the degree of similarity is greater than or equal to the predetermined value, the sensing device 12 is compatible, since the output tendency of the sensing device 12 approximates the output tendency of the sensing device 12 that generated the learning data of the processing modules 110. On the other hand, the compatibility determination unit 136 determines that, in the case where the degree of similarity is less than the predetermined value, the sensing device 12 is incompatible, since the output tendency of the sensing device 12 does not approximate the output tendency of the sensing device 12 that generated the learning data of the processing modules 110.

The switching unit 138 switches the sensing device 12 that outputs sensing data to the processing modules 110, based on the result of the determination by the compatibility determination unit 136. The switching unit 138 switches the sensing device 12, in the case where, for example, it is determined by the compatibility determination unit 136 that the sensing device 12 is incompatible. For example, the switching unit 138 transmits an output stop instruction to the sensing device 12 currently outputting input data to the processing modules 110, and transmits an output start instruction to another sensing device 12, via the communication I/F 195. On the other hand, the switching unit 138 does not switch the sensing device 12, in the case where it is determined by the compatibility determination unit 136 that the sensing device 12 is compatible, for example.

### 1-3. Operations

### 1-3-1. Metadata Generation Operations

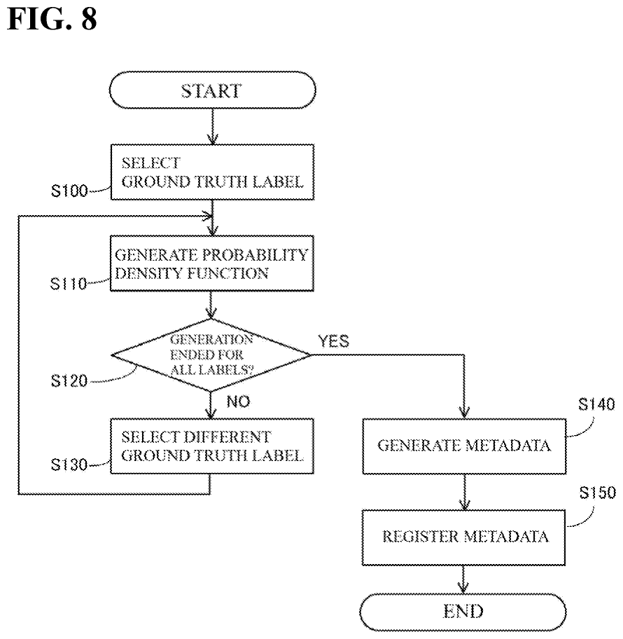

FIG. 8 is a flowchart showing an example of operations for generating first metadata. The processing shown in this flowchart is executed by the control unit 180 functioning as the first metadata generation module 120 (FIG. 6), after generation of the processing modules 110, for example.

Referring to FIG. 8, the control unit 180 selects one of a plurality of types of ground truth labels included in the plurality of learning data used in generating the processing modules 110 (step S100). The control unit 180 generates a probability density function based on a plurality of input data (included in the plurality of learning data used in generating the processing modules 110) associated with the selected type of ground truth label (step S110).

The control unit 180 determines whether a probability density function has been generated for all of the types of ground truth labels included in the plurality of learning data (step S120). When it is determined that a probability density function has not been generated for all of the ground truth labels (NO in step S120), the control unit 180 selects a type of ground truth label that differs from the ground truth labels for which a probability density function has already been generated (step S130). Thereafter, the control unit 180 repeats the processing from steps S110 to S130 until a probability density function is generated for all of the types of ground truth labels.

On the other hand, in step S120, when it is determined that a probability density function has been generated for all of the types of ground truth labels (YES in step S120), the control unit 180 generates first metadata based on all of the generated probability density functions (step S140). Thereafter, the control unit 180 registers the generated first metadata in the first metadata DB 150 (FIG. 6) (step S150).

In this way, in the first embodiment, first metadata is generated based on the probability density function of a plurality of input data (included in the learning data) associated with a ground truth label common to each thereof. Attributes of the sensing device 12 that generated the learning data are reflected in the first metadata. By referring to the first metadata, a sensing device 12 having attributes approximating the sensing device 12 that generated the learning data can be selected as the sensing device 12 for outputting input data to the processing modules 110, and inappropriate data being input to the processing modules 110 can be avoided, for example. Accordingly, with the virtual sensor management server 100, first metadata that is useful for avoiding input of inappropriate data to the processing modules 110 can be generated.

### 1-3-2. Compatibility Determination Operations of Sensing Device

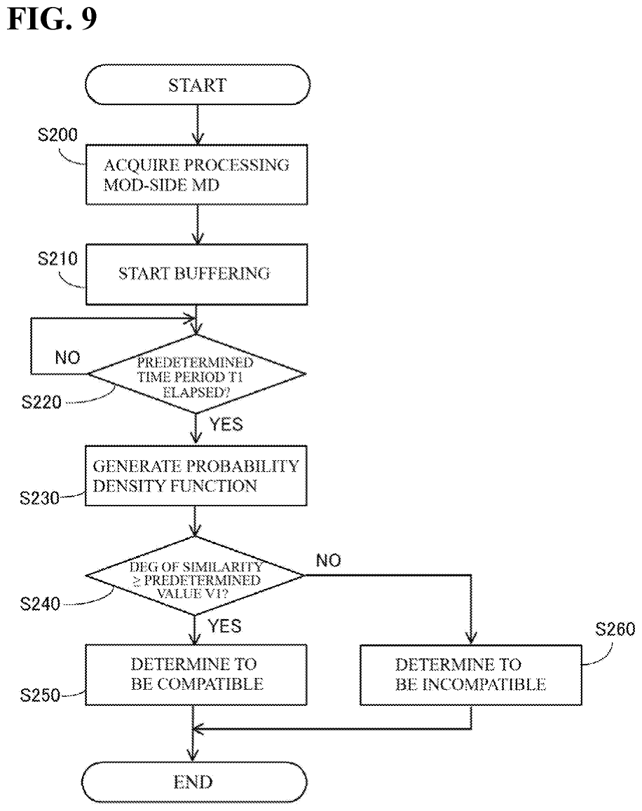

FIG. 9 is a flowchart showing an example of compatibility determination operations of a sensing device 12. The processing shown in this flowchart is executed at a predetermined interval, in the case where sensing data is being output to the processing modules 110 by a sensing device 12, for example. Also, the processing shown in this flowchart is executed by the control unit 180 functioning as the compatibility determination module 130.

Referring to FIG. 9, the control unit 180 acquires first metadata that is associated with the processing modules 110 from the first metadata DB 150 (step S200). The sensing data output by the sensing device 12 that is to undergo compatibility determination is input to the processing modules 110 that the first metadata acquired in step S200 is associated with.

The control unit 180 controls the data buffer 160 to start buffering the sensing data output to the processing modules 110 by the sensing device 12 (step S210). The control unit 180 determines whether a predetermined time period T1 has elapsed from the start of buffering (step S220). When it is determined that the predetermined time period T1 has not elapsed (NO in step S220), the control unit 180 continues buffering the sensing data until the predetermined time period T1 elapses. Note that the predetermined time period T1 is, for example, a time period during which the environment around the sensing device 12 does not change greatly.

On the other hand, when it is determined, in step S220, that the predetermined time period T1 has elapsed (YES in step S220), the control unit 180 generates a probability density function based on the plurality of sensing data stored in the data buffer 160 (step S230). The control unit 180 calculates the degree of similarity between the generated probability density function and each of the plurality of probability density functions included in the first metadata acquired in step S200, and determines whether one of the calculated degrees of similarity is greater than or equal to a predetermined value V1 (step S240).

When it is determined that one of the degrees of similarity is greater than or equal to the predetermined value V1 (YES in step S240), the control unit 180 determines that the sensing device 12 is compatible (step S250). On the other hand, when it is determined that all of the degrees of similarity are less than the predetermined value V1 (NO in step S240), the control unit 180 determines that the sensing device 12 is incompatible (step S260).

### 1-4. Features

As described above, in the first embodiment, the compatibility of the sensing device 12 outputting sensing data to the processing modules 110 is determined, based on first metadata that is associated with the processing modules 110. That is, in the first embodiment, the compatibility of the sensing device 12 is determined, after having adequately taken the attributes (output tendency) of the sensing device 12 that output the learning data used in generating the processing modules 110 into consideration. Accordingly, with the virtual sensor management server 100 according to the first embodiment, the compatibility of the sensing device 12 that outputs input data to the processing modules 110 can be determined more accurately.

Also, in the first embodiment, the probability density function generated based on a plurality of sensing data stored in the data buffer 160 is taken into consideration at the time of determining the compatibility of the sensing device 12. Accordingly, with the virtual sensor management server 100 according to the first embodiment, the compatibility of the sensing device 12 that outputs input data to the processing modules 110 can be determined more accurately.

### 2. Second Embodiment

In the above first embodiment, the compatibility of the sensing device 12 outputting sensing data to the processing modules 110 is determined based on first metadata associated with the processing modules 110 and buffered sensing data. As will be described in detail later, in the second embodiment, sensor-side metadata (hereinafter, also referred to as “second metadata”) is associated in advance with each sensing device 12, and the compatibility of the sensing device 12 is determined, based on the first and second metadata. Hereinafter, the description will focus on the differences from the first embodiment.

### 2-1. Configuration

### 2-1-1. Configuration of Overall System

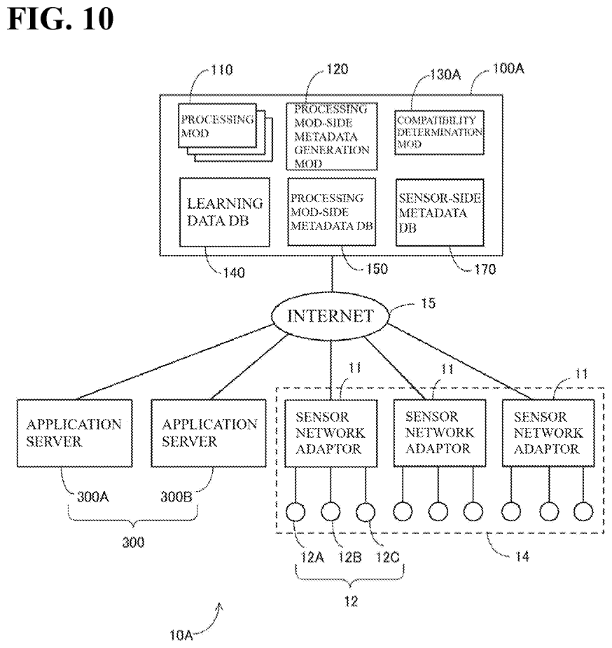

FIG. 10 is a diagram showing a sensor network system 10A in the second embodiment. In the example in FIG. 2, the sensor network system 10A includes a virtual sensor management server 100A, and the virtual sensor management server 100A includes a sensor-side metadata DB (hereinafter, also referred to as “second metadata DB”) 170 and a compatibility determination module 130A. The second metadata DB 170 and the compatibility determination module 130A will be described in detail later.

### 2-1-2. Hardware Configuration of Virtual Sensor Management Server

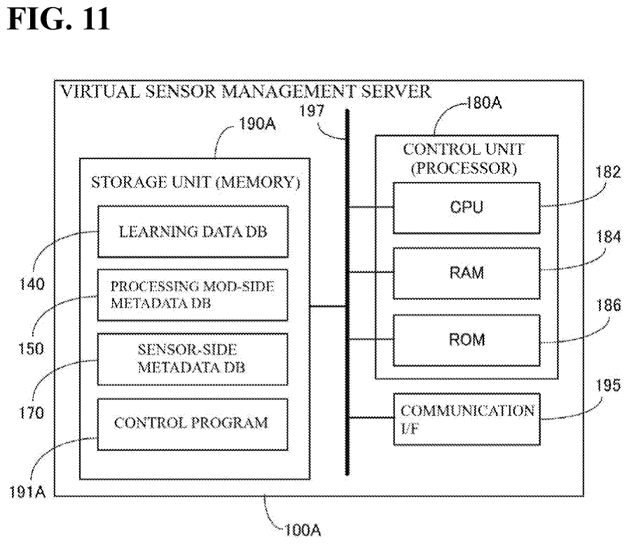

FIG. 11 is a diagram showing the hardware configuration of the virtual sensor management server 100A. In the example in FIG. 11, the virtual sensor management server 100A includes a control unit 180A and a storage unit 190A, and the storage unit 190A stores the second metadata DB 170 and a control program 191A.

The control unit 180A includes a CPU 182, a RAM 184 and a ROM 186, and is configured to control the constituent elements according to information processing. The storage unit 190A is an auxiliary storage device such as a hard disk drive or a solid-state drive, for example.

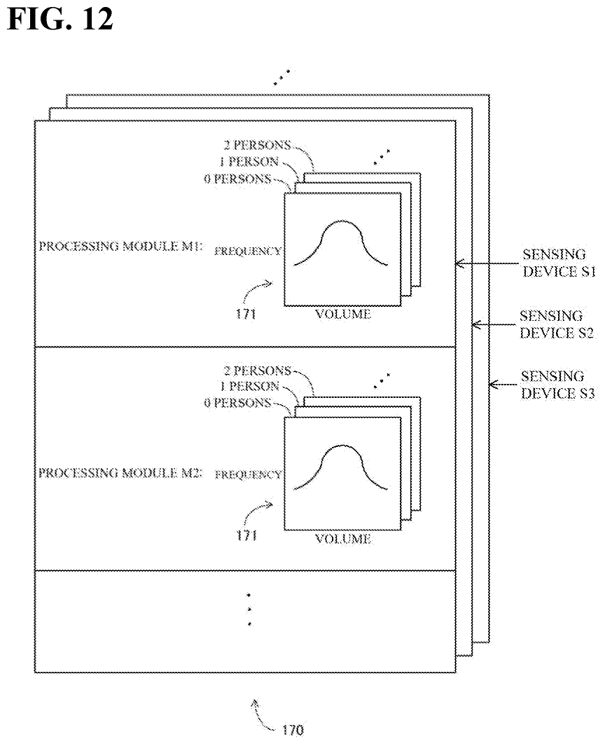

FIG. 12 is a diagram showing an example of the second metadata DB 170. In the example in FIG. 12, second metadata 171 is managed in the second metadata DB 170 for every sensing device 12 included in the sensor network unit 14. In this example, the second metadata DB 170 manages at least second metadata 171 that is associated with each of sensing devices S1, S2, and S3. Each second metadata is generated based on a plurality of input data (sensing data) output to the processing modules 110 by a sensing device 12. Note that, in the case where each of these plurality of input data is input to the processing modules 110, the processing modules 110 output a common output value.

For example, in relation to the sensing device S1, an example of the second metadata 171 is the probability density function of sensing data (output value of the sensing device S1 (input sensor)) in the case where a processing module M1 outputs output values (common output values), and the probability density function of sensing data in the case where a processing module M2 outputs output values. The second metadata 171 is, for example, generated in the case where a new sensing device 12 is added to the sensor network unit 14 and in the case where a new processing module 110 is generated in the virtual sensor management server 100A.

### 2-1-3. Software Configuration of Virtual Sensor Management Server

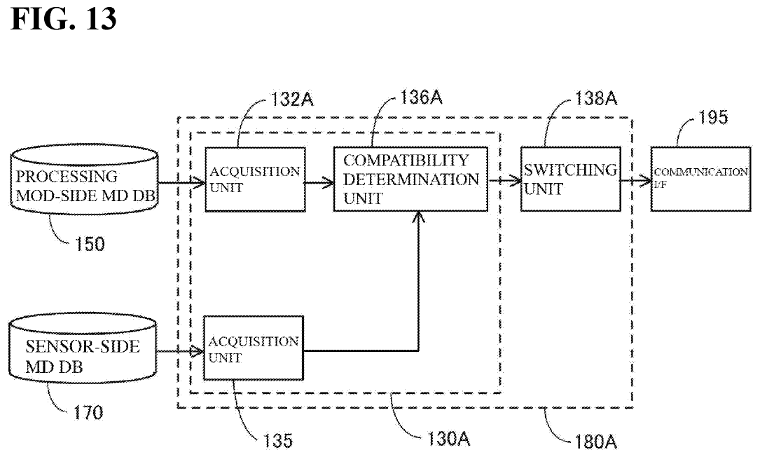

FIG. 13 is a diagram showing an example of part of the software configuration (including compatibility determination module 130A) of the virtual sensor management server 100A. The compatibility determination module 130A and a switching unit 138A are realized by a control unit 180A executing the control program 191A.

The compatibility determination module 130A determines the compatibility of the sensing device 12 outputting (or scheduled to output) sensing data to the processing modules 110, based on the first metadata associated with the processing modules 110 and the second metadata associated with the sensing device 12. The compatibility determination module 130A includes acquisition units 132A and 135 and a compatibility determination unit 136A.

The acquisition unit 132A acquires first metadata that is associated with the processing modules 110 from the first metadata DB 150. Note that the sensing device 12 that is to undergo compatibility determination may be outputting sensing data to these processing modules 110, or may be scheduled to output (not outputting at the present time) sensing data to these processing modules 110.

The acquisition unit 135 acquires, from the second metadata DB 170 (FIG. 12), second metadata that is associated with the processing modules 110 serving as the output destination (including scheduled output destination) of sensing data, from among the plurality of second metadata that are associated with the sensing device 12 that is to undergo compatibility determination.

The compatibility determination unit 136A determines the compatibility of the sensing device 12, based on the first metadata acquired by the acquisition unit 132A and the second metadata acquired by the acquisition unit 135. The compatibility determination unit 136A determines whether the degree of similarity between the first and second metadata is greater than or equal to a predetermined value, for example. Note that various known methods are used in calculating the degree of similarity.

The compatibility determination unit 136A determines, in the case where the degree of similarity is greater than or equal to the predetermined value, that the sensing device 12 is compatible, since the output tendency of the sensing device 12 approximates the output tendency of the sensing device 12 that generated the learning data of the processing modules 110. On the other hand, the compatibility determination unit 136A determines, in the case where the degree of similarity is less than the predetermined value, that the sensing device 12 is incompatible, since the output tendency of the sensing device 12 does not approximate the output tendency of the sensing device 12 that generated the learning data of the processing modules 110.

The switching unit 138A switches the sensing device 12 that outputs sensing data to the processing modules 110, based on the result of the determination by the compatibility determination unit 136A. The switching unit 138A switches the sensing device 12, in the case where, for example, it is determined by the compatibility determination unit 136A that the sensing device 12 is incompatible.

For example, the switching unit 138A, in the case where a sensing device 12 is outputting sensing data to the processing modules 110, transmits an output stop instruction to the sensing device 12 and transmits an output start instruction to another sensing device 12, via the communication I/F 195, when it is determined that the sensing device 12 is incompatible. In this case, the other sensing device 12 does not necessarily need to be the same type of sensing device 12 as the sensing device 12 to which the output stop instruction was transmitted. For example, in the case where the sensing device 12 to which the output stop instruction was transmitted is a surveillance camera, the sensing device 12 that is switched to may be a smartphone (with camera function). In short, the device switched from and the device switched to need only have the same type of function.

Note that the switching unit 138A does not perform switching in the case where the sensing device 12 is not yet outputting sensing data. In this case, when it is determined that the sensing device 12 is incompatible, the compatibility determination of another sensing device 12 is performed, for example.

### 2-2. Compatibility Determination Operations of Sensing Device

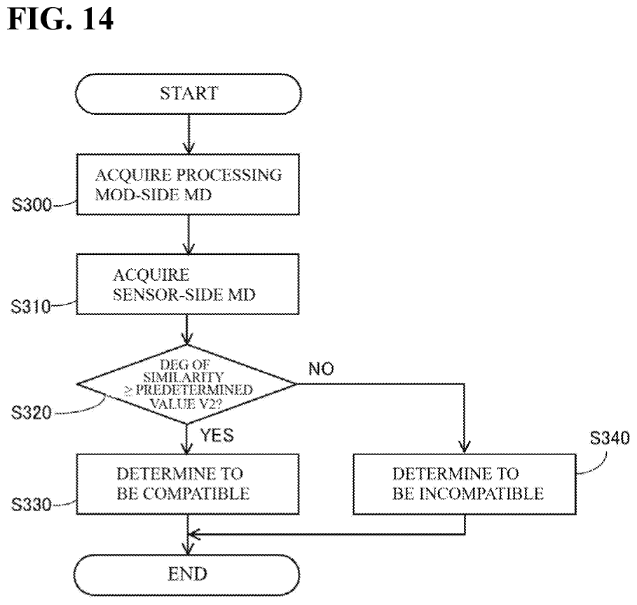

FIG. 14 is a flowchart showing an example of the compatibility determination operations of a sensing device 12. The processing shown in this flowchart is executed at a predetermined interval, in the case where sensing data is being output to the processing modules 110 by a sensing device 12, for example. Also, the processing shown in this flowchart is executed in the case of selecting a sensing device 12, in a state where sensing data is not yet being input to the processing modules 110, for example. Also, the processing shown in this flowchart is executed by the control unit 180A functioning as the compatibility determination module 130A.

Referring to FIG. 14, the control unit 180A acquires first metadata that is associated with the processing modules 110 from the first metadata DB 150 (step S300). The control unit 180A acquires, from the second metadata DB 170, second metadata that is associated with the processing modules 110 serving as the output destination (including scheduled output destination) of sensing data, from among the plurality of second metadata that are associated with the sensing device 12 that is to undergo compatibility determination (step S310).

The control unit 180A calculates the degree of similarity between the first metadata acquired in step S300 and the second metadata acquired in step S310, and determines whether the calculated degree of similarity is greater than or equal to a predetermined value V2 (step S320).

When it is determined that the degree of similarity is greater than or equal to the predetermined value V2 (YES in step S320), the control unit 180A determines that the sensing device 12 is compatible (step S330). On the other hand, when it is determined that the degree of similarity is less than the predetermined value V2 (NO in step S320), the control unit 180A determines that the sensing device 12 is incompatible (step S340).

### 2-3. Features

As described above, in the second embodiment, the compatibility of the sensing device 12 is determined, based on first metadata that is associated with the processing modules 110 and second metadata that is associated with the sensing device 12. Accordingly, with the virtual sensor management server 100A according to the second embodiment, the compatibility of the sensing device 12 can be determined more accurately, since the attributes of the sensing device 12 outputting input data to the processing modules 110 are adequately taken into consideration by referring to the second metadata.

Note that the processing modules 110 are an example of a “processing module” of the present invention, the sensing devices 12 are an example of a “device” of the present invention, and the compatibility determination apparatus 60 and the compatibility determination modules 130 and 130A are examples of a “compatibility determination apparatus” of the present invention. The first metadata is an example of “first metadata” of the present invention, the acquisition units 132 and 132A are examples of an “acquisition unit” of the present invention, and the compatibility determination units 136 and 136A are examples of a “determination unit” of the present invention. The data buffer 160 is an example of a “buffer” of the present invention, and the probability density function generation unit 134 is an example of a “probability density function generation unit” of the present invention. The second metadata is an example of “second metadata” of the present invention, and the acquisition unit 135 is an example of a “second acquisition unit” of the present invention.

### 3. Variations

First and second embodiments were described above, but the present invention is not limited to the foregoing first and second embodiments, and various modifications that do not depart from the gist of the invention can be made. Hereinafter, variations will be described. Note that the following variations can be combined as appropriate.

3-1

In the first and second embodiments, the learning data DB 140 is provided in the virtual sensor management servers 100 and 100A. However, the learning data DB 140 does not necessarily need to be provided in the virtual sensor management servers 100 and 100A. The learning data DB 140 may, for example, be stored in another server connected to the internet 15.

3-2

Also, in the first and second embodiments, the probability density function itself is included in the first metadata. However, the probability density function itself does not necessarily need to be included in the first metadata. For example, a configuration may be adopted in which only a range of input values whose frequency (probability) is less than a predetermined value in the probability density function or a range of input values whose frequency (probability) is greater than or equal to a predetermined value in the probability density function is included in the first metadata.

3-3

Also, in the second embodiment, the probability density function itself is included in the second metadata. However, the probability density function itself does not necessarily need to be included in the second metadata. For example, a configuration may be adopted in which only a range of input values whose frequency (probability) is less than a predetermined value in the probability density function or a range of input values whose frequency (probability) is greater than or equal to a predetermined value in the probability density function is included in the second metadata.

3-4

Also, in the first and second embodiments, sensing data output by a sensing device 12 is input to the processing modules 110. However, the data that is input to the processing modules 110 is not limited to sensing data that is output by a sensing device 12. For example, sensing data (e.g., data set) that is stored in a database on a server in advance may be input to the processing modules 110. Also, for example, the sensing data output by a virtual sensor may be input to the processing modules 110. That is, the agent that outputs data to the processing modules 110 does not necessarily need to be a sensing device 12, and may, for example, be a device such as a storage or a server that stores a large amount of data (data set). Also, the data set itself or a virtual sensor may be the agent that outputs data to the processing modules 110.

3-5

Also, in the first and second embodiments, the processing performed by the virtual sensor management servers 100 and 100A may be realized by a plurality of servers or the like.

### INDEX TO THE REFERENCE NUMERALS

10 Sensor network system
11 Sensor network adaptor
12 Sensing device
14 Sensor network unit
15 Internet
60 Compatibility determination apparatus
100 Virtual-sensor management server
110 Processing module
120 Processing module-side metadata (first metadata) generation module
122 Probability density function generation unit
124 Processing module-side metadata (first metadata) generation unit
126 Processing module-side metadata (first metadata) registration unit
130 Compatibility determination module
132, 132A, 135 Acquisition unit
134 Probability density function generation unit
136, 136A Compatibility determination unit
138 Switching unit
140 Learning data DB
150 Processing module-side metadata (first metadata) DB
151 First metadata
160 Data buffer
170 Sensor-side metadata (second metadata) DB
180, 180A Control unit
182 CPU
184 RAM
186 ROM
190, 190A Storage unit
191, 191A Control program
195 Communication I/F
197 Bus
300 Application server

1. A compatibility determination apparatus configured to determine a compatibility of an agent that outputs input data to a processing module,
the processing module being a learned model generated by using a plurality of learning data, and configured to generate, based on at least one piece of input data, output data that differs from the input data,
each of the plurality of learning data including the input data and a ground truth label of the output data associated with the input data,
first metadata being associated with the processing module, and
the first metadata being generated based on a probability density function of a plurality of the input data associated with the ground truth label common to each thereof,
the compatibility determination apparatus comprising:
a first acquisition unit configured to acquire the first metadata; and
a determination unit configured to determine the compatibility based on the first metadata.

2. The compatibility determination apparatus according to claim 1, further comprising:
a buffer configured to temporarily store the input data output to the processing module by the agent; and
a probability density function generation unit configured to generate a probability density function of a plurality of input data stored in the buffer,
wherein the determination unit is configured to determine the compatibility based on the first metadata and the probability density function generated by the probability density function generation unit.

3. The compatibility determination apparatus according to claim 2,
wherein the first metadata is the probability density function of the plurality of input data associated with the ground truth label common to each thereof, and
the determination unit is configured to determine that the agent is compatible, in a case where a degree of similarity between the first metadata and the probability density function generated by the probability density function generation unit is greater than or equal to a predetermined value.

4. The compatibility determination apparatus according to claim 1,
wherein second metadata is associated with the agent,
the second metadata is generated based on a probability density function of a plurality of input data each output to the processing module by the agent,
in a case where each of the plurality of input data is input to the processing module, the processing module outputs common output data,
the compatibility determination apparatus further comprises:
a second acquisition unit configured to acquire the second metadata, and
the determination unit is configured to determine the compatibility based on the first and second metadata.

5. The compatibility determination apparatus according to claim 4,
wherein the first metadata is the probability density function of the plurality of input data associated with the ground truth label common to each thereof,
the second metadata is the probability density function of the plurality of input data each output to the processing module by the agent, and
the determination unit is configured to determine that the agent is compatible, in a case where a degree of similarity between the first and second metadata is greater than or equal to a predetermined value.

6. The compatibility determination apparatus according to claim 1,
wherein the agent comprises a sensor, and
the input data comprises sensing data output by the sensor.

7. The compatibility determination apparatus according to claim 1, wherein the processing module is configured to generate the output data based on a plurality of the input data.

8. The compatibility determination apparatus according to claim 1, wherein a virtual sensor is formed by the processing module and the agent that outputs the input data to the processing module.

9. A compatibility determination method for determining a compatibility of an agent that outputs input data to a processing module,
the processing module being a learned model generated by using a plurality of learning data, and configured to generate, based on at least one piece of input data, output data that differs from the input data,
each of the plurality of learning data including the input data and a ground truth label of the output data associated with the input data,
first metadata being associated with the processing module, and
the first metadata being generated based on a probability density function of a plurality of the input data associated with the ground truth label common to each thereof,
the compatibility determination method comprising:
acquiring the first metadata; and
determining the compatibility based on the first metadata.

10. A non-transitory computer-readable storage medium storing a program that causes a computer to execute processing for determining a compatibility of an agent that outputs input data to a processing module,
the processing module being a learned model generated by using a plurality of learning data, and configured to generate, based on at least one piece of input data, output data that differs from the input data,
each of the plurality of learning data including the input data and a ground truth label of the output data associated with the input data,
first metadata being associated with the processing module, and
the first metadata being generated based on a probability density function of a plurality of the input data associated with the ground truth label common to each thereof,
the program being configured to cause, which when read and executed, the computer to perform operations comprising:
acquiring the first metadata; and
determining the compatibility based on the first metadata.

11. The compatibility determination apparatus according to claim 2,
wherein the agent comprises a sensor, and
the input data comprises sensing data output by the sensor.

12. The compatibility determination apparatus according to claim 2, wherein the processing module is configured to generate the output data based on a plurality of the input data.

13. The compatibility determination apparatus according to claim 2, wherein a virtual sensor is formed by the processing module and the agent that outputs the input data to the processing module.

14. The compatibility determination apparatus according to claim 3,
wherein the agent comprises a sensor, and
the input data comprises sensing data output by the sensor.

15. The compatibility determination apparatus according to claim 3, wherein the processing module is configured to generate the output data based on a plurality of the input data.

16. The compatibility determination apparatus according to claim 3, wherein a virtual sensor is formed by the processing module and the agent that outputs the input data to the processing module.

17. The compatibility determination apparatus according to claim 4,
wherein the agent comprises a sensor, and
the input data comprises sensing data output by the sensor.

18. The compatibility determination apparatus according to claim 4, wherein the processing module is configured to generate the output data based on a plurality of the input data.

19. The compatibility determination apparatus according to claim 4, wherein a virtual sensor is formed by the processing module and the agent that outputs the input data to the processing module.
